(19) United States
(12) Patent Application Publication
(10) Pub. No.: US 2010/0153110 A1
(43) Pub. Date: Jun. 17, 2010

(54) VOICE RECOGNITION SYSTEM AND METHOD OF A MOBILE COMMUNICATION DEVICE

(75) Inventor: TANG-YU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/547,642

(22) Filed: Aug. 26, 2009

(30) Foreign Application Priority Data
Dec. 11, 2008 (CN) 200810306184.9

(51) Int. Cl. G10L 17/00

(52) U.S. Cl. 704/248; 704/246; 704/E17.002

(57) ABSTRACT

A voice recognition system and method of a mobile communication device. The mobile communication device has a storage device which stores voice templates and characteristics of each of the voice templates. The method recognizes voice data form a sound input, calculates a similarity ratio between characteristics of the sound input and the characteristics of each of the voice templates, and sorts the voice templates according to the similarity ratio in a list of text symbols representing the voice templates. The list of text symbols can be selected as a proper text input by a user.

### BACKGROUND

1. Technical Field

Embodiments of the present disclosure generally relate to techniques of message input, and more particularly to a voice recognition system and method of a mobile communication device.

2. Description of Related Art

Mobile communication devices, such as mobile phones or personal data assistants (PDA), are capable of using short message services. A mobile communication device may have multiple input methods to operate short message services. However, the multiple input methods may require manual operations to switch between one input method to another input method while editing/composing a short message. For example, to input a symbol into the short message while using a character input method, the input method needs to be manually changed to a symbol input method. This process is quite troublesome and inefficient.

Therefore, there is a voice recognition system and method used in a mobile communication device, so as to overcome the above-mentioned disadvantages.

### BRIEF DESCRIPTION OF THE DRAWINGS

FIG. 1 is a block diagram of one embodiment of a voice recognition system of a mobile communication device.

FIG. 2 is a block diagram of one embodiment of function modules of a voice recognition system included in the system of FIG. 1.

FIG. 3 is a flowchart illustrating one embodiment of a speech recognition method of a mobile communication device.

FIG. 4 shows a schematic and graph diagram of sound intensity values for different times of a speech data.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

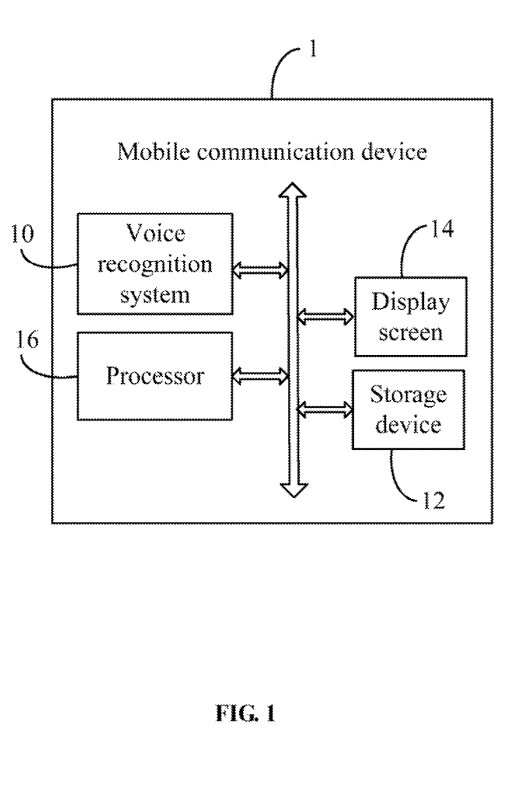

FIG. 1 is a block diagram of one embodiment of a voice recognition system 10 of a mobile communication device 1. In one embodiment, the voice recognition system 10 is installed in the mobile communication device 1. The mobile communication device 1 typically includes a storage device 12, a display screen 14, and at least one processor 16. The storage device 12 stores voice templates and characteristics of each of the voice templates. The voice templates can be, but are not limited to, of punctuations, numerals, and so on. The voice recognition system 10 is operable to recognize voice data from a sound input by a user, calculate a similarity ratio between characteristics of the sound input and the characteristics of each of the voice templates stored in the storage device 12, and sort the voice templates according to the similarity ratio in a list of text symbols representing the voice templates. Such list of text symbols can be selected as a proper text input by the user when the list is displayed on the display screen 14. In the embodiment, the voice recognition system 10 allows inputting text more easily.

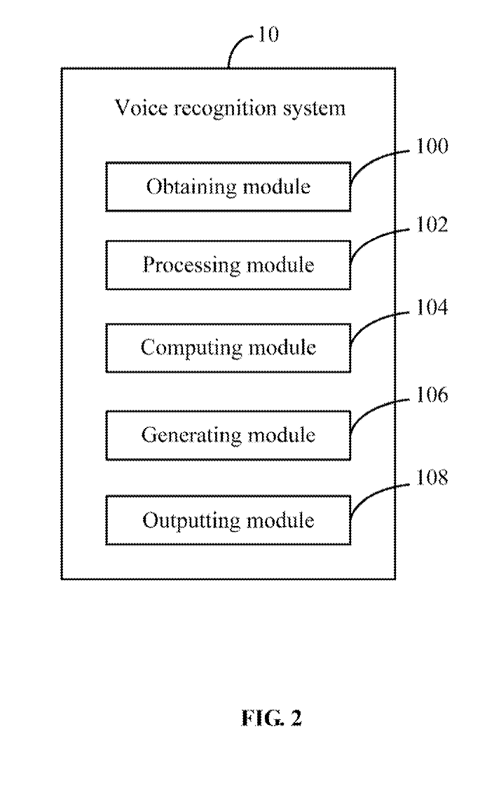

FIG. 2 is a block diagram of one embodiment of function modules of the voice recognition system 10 of FIG. 1. The voice recognition system 10 may include a plurality of instructions, and executed by the processor 16 of the mobile communication device 1. In one embodiment, the voice recognition system 10 may include an obtaining module 100, a processing module 102, a calculating module 104, a generating module 106, and an outputting module 108.

Once speech recognition feature is invoked, the obtaining module 100 is operable to recognize voice data from a sound input. For example, if the word, “colon” is read out loud, the obtaining module 100 recognizes the sound of “colon” and corresponding textual representation “:”.

The processing module 102 is operable to process the voice data to identify characteristics of the voice data. In the embodiment, the characteristics can include, but not limited to, a frequency spectrum and a pitch of the voice data, which can express an essential content of the voice data. The voice data may include a speech data and a static voice data.

In one embodiment, the processing module 102 can distinguish the speech data from the static voice data by using a sound intensity detecting method, and determines a start point and an end point of the speech data by processing the speech data. In another embodiment, the processing module 102 can use a high-pass filter to compensate high frequency signals in the speech data attenuated.

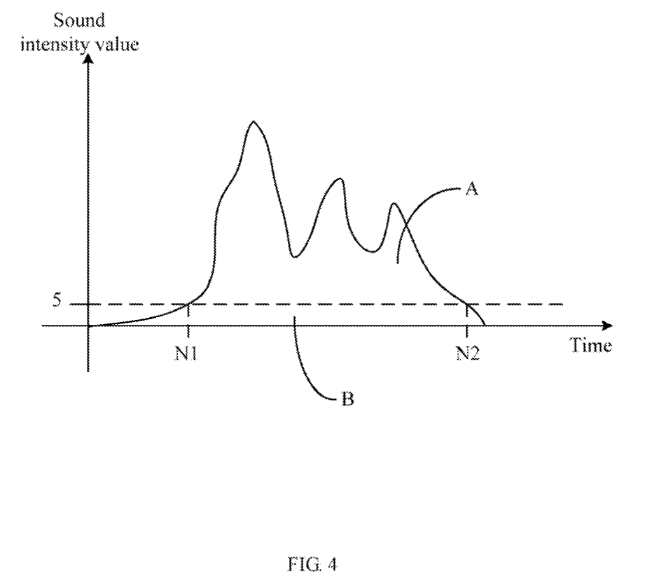

In the embodiment, the sound intensity detecting method is a method for setting a threshold value that can differentiating the voice data into two sections according to sound intensity of the voice data. FIG. 4 shows a schematic and graph diagram of sound intensity values for different times of a voice data. In FIG. 4, the horizontal axis represents the times of the voice data, and the vertical axis represents the sound intensity values of the voice data. The first section (denoted as “A”), whose sound intensity values are greater than the threshold value “5”, is the speech data. The second section (denoted as “B”), whose sound intensity values are not greater than the threshold value “5”, is the static voice data. The processing module 102 detects that the point “N1” is the start point of the speech data, and the point “N2” is the end point of the speech data.

The calculating module 104 is operable to calculate a similarity ratio between the characteristics of the sound input and the characteristics of each of the voice templates.

The generating module 106 is operable to sort the voice templates according to the similarity ratio in a list of text symbols representing the voice templates.

The outputting module 108 is operable to display the list on the display screen 14. Each text symbols in the list can be then selected as text input.

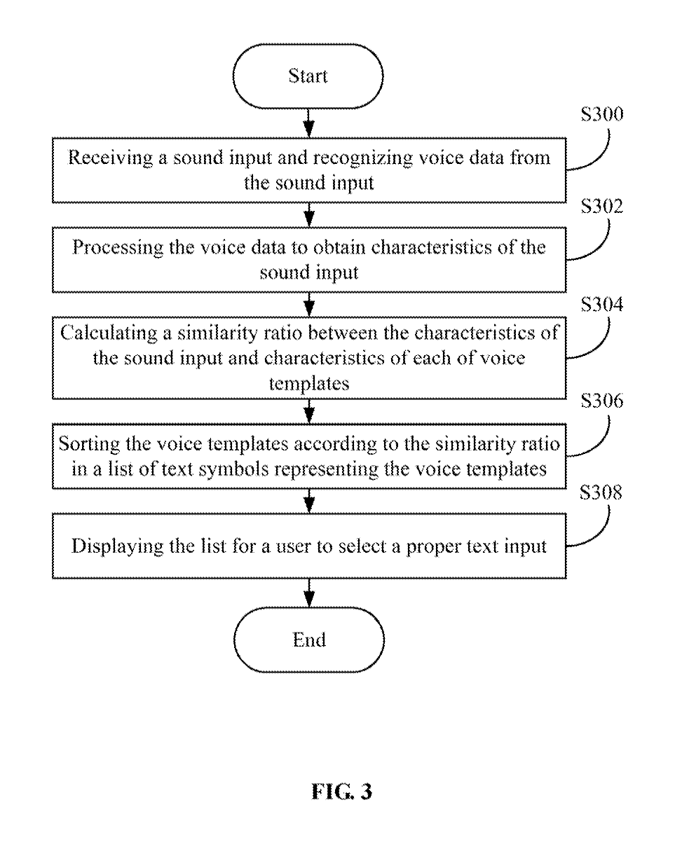

FIG. 3 is a flowchart illustrating one embodiment of a voice recognition method of the mobile communication device 1 by using the voice recognition system 10 as described in FIG. 1. Depending on the embodiment, additional blocks in the flow of FIG. 3 may be added, others removed, and the ordering of the blocks may be changed.

In block S300, the obtaining module 100 recognizes voice data from a sound input. The voice data may be a punctuation or a numerical number. In the embodiment, the voice data includes a speech data and a static voice data.

In block S302, the processing module 102 processes the voice data to identify characteristics of the voice data. The characteristics may include, but not limited to, a frequency spectrum and a pitch of the voice data.

In one embodiment, the processing module 102 distinguishes the speech data from the static voice data by using a sound intensity detecting method, and determines a start point and an end point of the speech data by processing the speech data. The sound intensity detecting method is a method for setting a threshold value which can differentiating the voice data into two seconds (denoted as “part A” and “part B”), as described in FIG. 4. Referring to FIG. 4, which shows a schematic and graph diagram of sound intensity values of different times of a voice data. From the schematic and graph diagram, the start point “N1” and the end point “N2” of the speech data can be determined. In another embodiment, the processing module 102 further compensates high frequency signals in the speech data attenuated by using a high-pass filter.

In block S304, the calculating module 104 calculates a similarity ratio between the characteristics of the sound input and the characteristics of each of the voice templates.

In block S306, the generating module 106 sorts the voice templates according to the similarity ratio in a list of text symbols representing the voice templates.

In block S308, the outputting module 108 displays the list on the display screen 14 for the user 2 selecting a proper text input. For example, if the list is shown as: “1:”, “2.”, “3,” and “4′”, the user can select a proper text input to match with the sound input.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A voice recognition method of a mobile communication device, the method comprising:
pre-storing voice templates and characteristics of each of the voice templates in a storage device of the mobile communication device;
receiving a sound input by a user and recognizing voice data from the sound input;
processing the voice data to identify characteristics of the sound input;
calculating a similarity ratio between the characteristics of the sound input and the characteristics of each of the voice templates;
sorting the voice templates according to the similarity ratio in a list of text symbols representing the voice templates; and
displaying the list on the mobile communication device for the user to select a proper text input.

2. The method as described in claim 1, wherein the voice data comprise speech data and static voice data.

3. The method as described in claim 2, wherein the processing block comprises:
distinguishing the speech data from the static voice data;
determining a start point and an end point of the speech data; and
compensating high frequency signals in the speech data attenuated.

4. The method as described in claim 2, wherein the characteristics comprise a frequency spectrum and a pitch of the voice data.

5. A storage medium having stored thereon instructions that, when executed by a processor of a mobile communication device, causing the mobile communication device to perform a voice recognition method, the method comprising:
pre-storing voice templates and characteristics of each of the voice templates in a storage device of the mobile communication device;
receiving a sound input by a user and recognizing voice data from the sound input;
processing the voice data to identify characteristics of the sound input;
calculating a similarity ratio between the characteristics of the sound input and the characteristics of each of the voice templates;
sorting the voice templates according to the similarity ratio in a list of text symbols representing the voice templates; and
displaying the list on the mobile communication device for the user to select a proper text input.

6. The method as described in claim 5, wherein the characteristics comprise a frequency spectrum and a pitch of the voice data.

7. The storage medium as described in claim 5, wherein the voice data comprise speech data and static voice data.

8. The storage medium as described in claim 7, wherein the processing comprises:
distinguishing the speech data from the static voice data;
determining a start point and an end point of the speech data; and
compensating high frequency signals in the speech data attenuated.

9. A voice recognition system of a mobile communication device, the mobile communication device having a storage device which stores voice templates and characteristics of each of the voice templates, the voice recognition system comprising:
an obtaining module operable to receive a sound input by a user and recognize voice data from the sound input;
a processing module operable to process the speech data to identify characteristics of the sound input;
a calculating module operable to calculate a similarity ratio between the characteristics of the sound input and the characteristics of each of the voice templates;
a generating module operable to sort the voice templates according to the similarity ratio in a list of text symbols representing the voice templates; and
an outputting module operable to display the list on a display screen of the mobile communication device for the user to select a proper text input.

10. The system as described in claim 9, wherein the characteristics comprise a frequency spectrum and a pitch of the voice data.

11. The system as described in claim 9, wherein the voice data comprise speech data and static voice data.

12. The system as described in claim 11, wherein the processing module is further operable to:
distinguish the speech data from the static voice data;
determine a start point and an end point of the speech data; and
compensate high frequency signals in the speech data attenuated.
